(19) United States
(12) Patent Application Publication
(10) Pub. No.: US 2012/0173092 A1
(43) Pub. Date: Jul. 5, 2012

(54) SAFETY SYSTEM FOR WORK VEHICLE

(76) Inventors: Mitchell L. SORBY, Wichita, KS (US); Tim A. Newlin, Wichita, KS (US)

(21) Appl. No.: 12/984,739

(22) Filed: Jan. 5, 2011

(51) Int. Cl. G06F 7/00

(52) U.S. Cl. 701/50

(57) ABSTRACT

A work vehicle includes a motor associated with selectable movement of a frame by operator controls. The frame structurally carries a cab structure and a first manipulating structure associated with a first implement for performing work. The first manipulating structure is selectably movable by operator controls located in the cab structure, the cab structure including a transparent member, the transparent member in communication with a source of electrical power. In response to an interruption in communication between the transparent member and the source of electrical power, the first manipulating structure is no longer selectably movable by the operator controls, while the operator controls continuously permit selectable movement of the frame by the motor.

### FIELD OF THE INVENTION

The present invention relates generally to the field of work vehicles having operator cabs. It relates more particularly to safety systems for work vehicles having operator cabs.

### BACKGROUND OF THE INVENTION

Work vehicles, such as skid steer loaders, include an implement with which to perform work, as well as a cab structure to protect the operator during operation of the work vehicle. The cab structure may include a windshield along with other side or rear glass barriers to provide an operator with the ability to perceive and interact with portions of a work environment that are exterior of the cab structure. During operation of the work vehicle, the windshield or glass barriers may become damaged, potentially posing an immediate safety threat to the operator or others near the work vehicle. In response to this threat, it may be prudent to prevent selective operation of the implement by an operator positioned within the cab structure. However, totally disabling operation of the work vehicle immediately after windshield damage has occurred, e.g., the ability to move the work vehicle, especially if the implement was in an extended position and/or the location of the work vehicle was isolated or precariously positioned, could greatly complicate prospective repair efforts to the work vehicle.

Accordingly, it would be advantageous to prevent selective operation of the implement by an operator positioned within the cab structure, while permitting relocation of the work vehicle under its own power.

### SUMMARY OF THE INVENTION

The present invention further relates to a work vehicle includes a motor associated with selectable movement of a frame by operator controls. The frame structurally carries a cab structure and a first manipulating structure associated with a first implement for performing work. The first manipulating structure is selectably movable by operator controls located in the cab structure, the cab structure including a transparent member, the transparent member in communication with a source of electrical power. In response to an interruption in communication between the transparent member and the source of electrical power, the first manipulating structure is no longer selectably movable by the operator controls, while the operator controls continuously permit selectable movement of the frame by the motor.

The present invention further relates to a work vehicle including a motor associated with selectable movement of a frame by operator controls. The frame is structurally carries a cab structure and a first manipulating structure associated with a first implement for performing work. The first manipulating structure is selectably movable by operator controls located in the cab structure, the cab structure including a transparent member. The first manipulating structure is manually movable between a first position toward a second position. An end of the first manipulating structure in the second position has an elevation that is less than an elevation of the end of the first manipulating structure in the first position, the transparent member in communication with a source of electrical power. In response to an interruption in communication between the transparent member and the source of electrical power due to at least one of at least a partial structural failure of the transparent member and to movement of the transparent member with respect to the frame, the first manipulating structure being no longer selectably movable by the operator controls, while the operator controls continuously permit selectable movement of the frame by the motor.

An advantage of the present invention is the ability to prevent selective operation of a manipulating structure associated with an implement of a work vehicle by an operator positioned within the cab structure, while permitting relocation of the work vehicle under its own power.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a top perspective view of an embodiment of a work vehicle.

FIG. 2 is a diagram of an embodiment of an electrical circuit of a work vehicle.

FIG. 3 is a diagram of a further embodiment of an electrical circuit of a work vehicle.

Wherever possible, the same reference numbers will be used throughout the drawings to refer to the same or like parts.

### DETAILED DESCRIPTION OF THE INVENTION

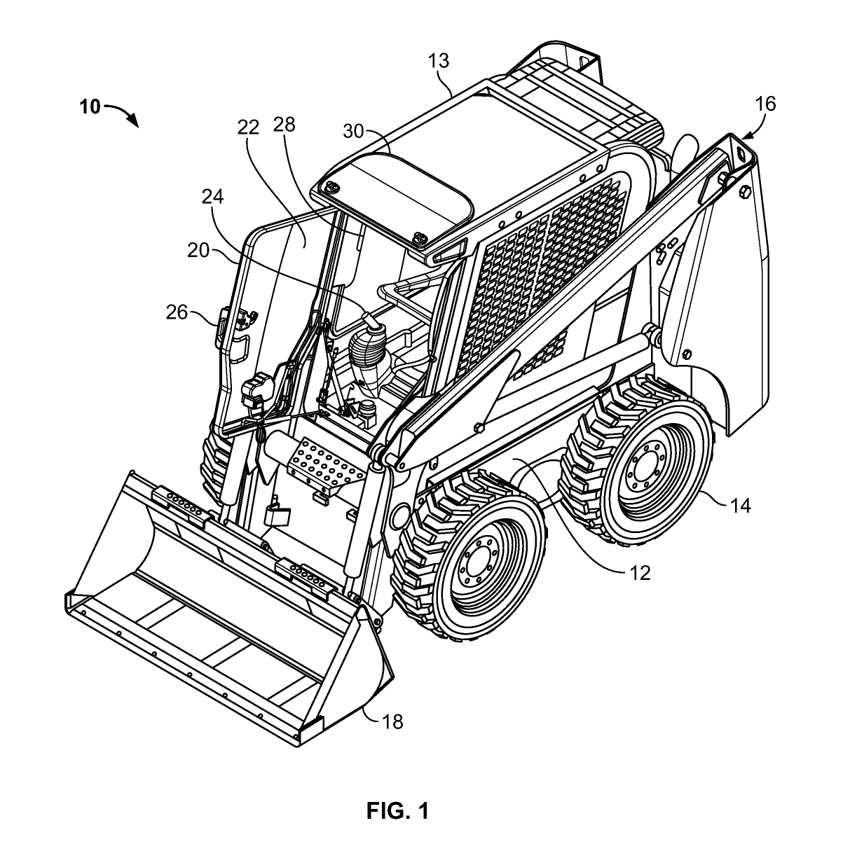

FIG. 1 shows a work vehicle 10 provided with a frame 12 that rotatably carries a plurality of wheels 14. Alternately, a track drive or other appropriate drive system to movably drive the frame may be used. A first manipulating structure 16 includes an arrangement of structural members and actuators controllable by an operator (not shown) such as by operator controls 24, such as a joystick or lever, to manipulate a first implement 18 to perform work. As further shown in FIG. 1, operator controls 24 are located within a cab structure 13. Frame 12 structurally supports cab structure 13 to surround and protect the operator. A door 20 provides operator ingress/egress to work vehicle 10, including a transparent member 22 through which an operator may view a work environment exterior of the work vehicle. An alternate embodiment, the work vehicle may not have a door. As further shown in FIG. 1, the cab structure may include a pair of opposed transparent members 28, permitting the operator to view portions of the work environment that are lateral to and exterior of the work vehicle. As yet further shown in FIG. 1, the cab structure may include a transparent member 30 permitting the operator to view portions of the work environment that are located vertically above the cab structure. In one embodiment, the cab structure may be comprised of a unitary transparent member.

Although transparent members 22, 28, 30 may be composed of tempered glass or of a suitable transparent material that is resistant to damage, such damage may still occur during operation of the work vehicle. That is, the transparent member may incur at least a partial structural failure by virtue of impact with objects encountered during operation of the work vehicle. Examples of partial structural failure include but are not limited to cracks formed in the transparent member or a removal of a portion of the transparent member, such as an opening (not shown) formed in the transparent member. Alternately, damage to one or more of the transparent members may include movement of the transparent member with respect to the frame of the work vehicle. That is, at least in one embodiment, at least a portion of the transparent member or the entire transparent member may be moved or displaced with respect to the work vehicle frame, in which the transparent member may comprise the cab structure, such as with a unitary transparent member.

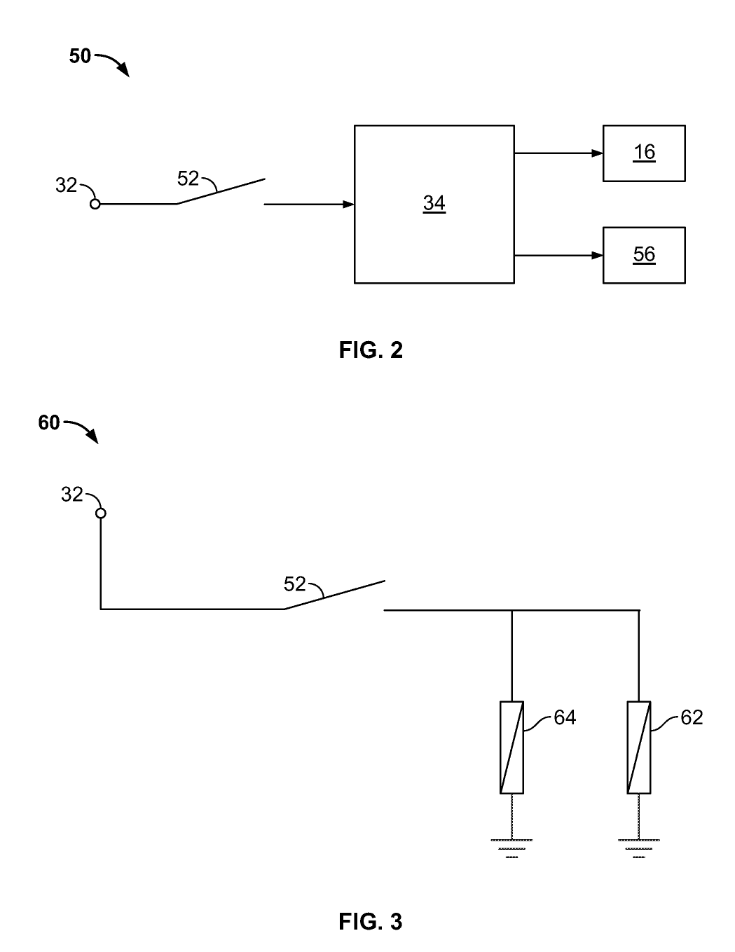

FIG. 2 shows an exemplary embodiment of an electrical circuit 50 usable with a work vehicle. Electrical circuit 50 includes a source of electrical power 32, such as a battery or a generator, that is in electrical communication with transparent members, such as transparent members 22, 28, 30. This electrical communication is shown as an electrical connection 52, such as symbolized by a switch in FIG. 2. Electrical connection 52 may manifest itself in many different ways. For example, a conductor (not shown) extending from source of electrical power 32 may include conductive cables, wires, a conductive frame that at least partially surrounds transparent members 22, 28, 30 or other suitable arrangement that electrically connects the source of electrical power to transparent members 22, 28, 30. The transparent members may include a strip of conductive material secured to at least one side of the transparent members, or in one embodiment, to at least one side of multiple-layered transparent members. In a further embodiment, the transparent members may include a conductive layer, such as a spray or other role of conductive material that is secured to at least one side of the transparent member. Further embodiment, the transparent members may include at least a portion in which conductive particles may be distributed within at least one layer of a single layered transparent member or of a multi-layered transparent number.

As further shown in FIG. 2, electrical circuit 50 includes a micro-processor based electronic control module 34 with software control logic to calculate and control appropriate vehicle control outputs based upon vehicle system status inputs that is in electrical communication with transparent members via electrical connection 52 and source of electrical power 32. Additionally, control module 34 is in electrical communication with first manipulating structure 16 that is associated with first implement 18 and a second manipulating structure 56 that is associated with a second implement (not shown).

FIG. 3 shows a further exemplary embodiment of an electrical circuit 60 similar to electrical circuit 50. Electrical circuit 60 includes a first solenoid 62 that activates, engages or otherwise maintains/results in operation of first manipulating structure 16 associated with first implement 18, so long as electrical circuit 60 remains continuous or uninterrupted. Similarly, electrical circuit 60 includes a second solenoid 64 that activates, engages or otherwise maintains/results in operation of second manipulating structure 56 associated with a second implement, so long as electrical circuit 60 remains continuous or uninterrupted. As further shown in FIG. 3, first solenoid 62 and second solenoid 64 are arranged in parallel. In one embodiment, electrical circuits 50, 60 may be interconnected or otherwise utilized to form a single electrical circuit.

As a result of electrical circuit 50, by itself or in combination with electrical circuit 60, an interruption in electrical communication or electrical connection 52 between at least one of transparent members 22, 28, 30 and source of electrical power 32, results in first manipulating structure 16 associated with first implement 18 and second manipulating structure 56 associated with a second implement being no longer selectably movable by operator controls 24 (FIG. 1). An interruption in electrical communication or electrical connection 52 may occur for different reasons. For example, a partial structural failure of at least one of the transparent members may occur such as in the form of a crack formed in a transparent member or removal of a portion of a transparent member. Alternately, an interruption in electrical communication may be due to movement of a transparent member with respect to frame 12 (FIG. 1).

It is to be understood that the first manipulating structure 16 associated with first implement 18 could correspond to an attachment for use with a skid steer loader, and that a second manipulating structure 56 associated with a second implement could correspond to a second or auxiliary implement that is also used with the skid steer loader. Alternately, the first and second manipulating structures 16, 56 could correspond to those associated with a loader backhoe, also referred to as a tractor loader backhoe.

As a result of electrical circuit 50, by itself or in combination with electrical circuit 60, in response to an interruption in communication between at least one of the transparent members 22, 28, 30 and source of electrical power 32, first manipulating structure 16 associated with first implement 18 and second manipulating structure 56 associated with a second implement are no longer selectably movable by operator controls 24, while the operator can continuously operate or selectably move the frame of the work vehicle by virtue of operating the motor. Stated another way, the operator can continue to guide/propel the work vehicle, i.e., by motor-driven rotation of wheels 14 or movable tracks, in order to move the work vehicle to a safe/convenient position for a subsequent maintenance, such as replacing the damaged transparent member(s).

It is to be understood that the term first manipulating structure or second manipulating structure not only refers to the device that is to perform work, and further includes respective first and second implements, such as a bucket or blade, but also refers to structural/fluid components required to control the manipulating structures. In other words, as a result of an interruption in communication between the transparent members and source of electrical power, operator controls located in the cab structure normally associated with effecting movement of the manipulating structures can no longer be used until the formerly interrupted communication is restored. In one embodiment, it may be possible to manually move (lower) an end of a first manipulating structure 16 between a first position and a second position, e.g., from the first position toward the second position by force of gravity, in which the end of the first manipulating structure 16 (such as near a corresponding first implement 18) that is located in the second position has an elevation that is less than the elevation associated with the end of the first manipulating structure that is located in the first position. In another embodiment, it may be possible to manually move (lower) an end of a second manipulating structure 56 between a first position and a second position, in which the end of the second manipulating structure 56 (such as near a corresponding second implement (not shown)) that is located in the second position has an elevation that is less than the elevation associated with the end of the second manipulating structure that is located in the first position. For example, a manually actuatable or engagable bleed valve may permit the end of the first manipulating structure and/or the second manipulating structure to be lowered despite the interruption in electrical communication (electrical connection 52) as described above.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A work vehicle comprising:
a motor associated with selectable movement of a frame by operator controls; and
the frame structurally carrying a cab structure and a first manipulating structure associated with a first implement for performing work, the first manipulating structure selectably movable by operator controls located in the cab structure, the cab structure including a transparent member, the transparent member in communication with a source of electrical power;
wherein in response to an interruption in communication between the transparent member and the source of electrical power, the first manipulating structure is no longer selectably movable by the operator controls, while the operator controls continuously permit selectable movement of the frame by the motor.

2. The work vehicle of claim 1, wherein the interruption in communication between the transparent member and the source of electrical power is due to at least a partial structural failure of the transparent member.

3. The work vehicle of claim 2, wherein the structural failure comprises a crack formed in the transparent member.

4. The work vehicle of claim 2, wherein the structural failure comprises removal of a portion of the transparent member.

5. The work vehicle of claim 1, wherein the interruption in communication between the transparent member and the source of electrical power is due to movement of the transparent member with respect to the frame.

6. The work vehicle of claim 1, wherein subsequent to the interruption in communication, the first manipulating structure is manually movable between a first position toward a second position, an end of the first manipulating structure in the second position having an elevation that is less than an elevation of the end of the first manipulating structure in the first position.

7. The work vehicle of claim 1, wherein the interruption in communication between the transparent member and the source of electrical power is due to movement of the transparent member with respect to the cab structure.

8. The work vehicle of claim 1, wherein the work vehicle is a skid steer loader or a loader backhoe.

9. The work vehicle of claim 1, comprising a second manipulating structure associated with a second implement for performing work, the second manipulating structure selectably movable by operator controls located in the cab structure, wherein in response to an interruption in communication between the transparent member and the source of electrical power, the second manipulating structure is no longer selectably movable by the operator controls.

10. The work vehicle of claim 9, wherein subsequent to the interruption in communication, the second manipulating structure is manually movable between a first position toward a second position, an end of the second manipulating structure in the second position having an elevation that is less than an elevation of the end of the second manipulating structure in the first position.

11. The work vehicle of claim 9, comprising a control module in communication between the first manipulating structure and second manipulating structure, and the transparent member.

12. The work vehicle of claim 9, comprising a first solenoid in communication with the transparent member and the first manipulating structure, and comprising a second solenoid in communication with the transparent member and the second manipulating structure.

13. The work vehicle of claim 1, wherein the interruption in communication between the transparent member and the source of electrical power is due to actuation of a device.

14. A work vehicle comprising:
a motor associated with selectable movement of a frame by operator controls; and
the frame structurally carrying a cab structure and a first manipulating structure associated with a first implement for performing work, the first manipulating structure selectably movable by operator controls located in the cab structure, the cab structure including a transparent member, the first manipulating structure manually movable between a first position toward a second position, an end of the first manipulating structure in the second position having an elevation that is less than an elevation of the end of the first manipulating structure in the first position, the transparent member in communication with a source of electrical power;
wherein in response to an interruption in communication between the transparent member and the source of electrical power due to at least one of at least a partial structural failure of the transparent member and to movement of the transparent member with respect to the frame, the first manipulating structure being no longer selectably movable by the operator controls, while the operator controls continuously permit selectable movement of the frame by the motor.

15. The work vehicle of claim 14, wherein the structural failure comprises a crack formed in the transparent member.

16. The work vehicle of claim 14, comprising a second manipulating structure associated with a second implement for performing work, the second manipulating structure selectably movable by operator controls located in the cab structure, wherein in response to an interruption in communication between the transparent member and the source of electrical power, the second manipulating structure is no longer selectably movable by the operator controls.

17. The work vehicle of claim 16, wherein the second manipulating structure is movable between a first position toward a second position, an end of the second manipulating structure in the second position having an elevation that is less than an elevation of the end of the second manipulating structure in the first position.

18. The work vehicle of claim 16, comprising a control module in communication between the first manipulating structure and second manipulating structure and the transparent member.

19. The work vehicle of claim 16, comprising a first solenoid in communication with the transparent member and the first manipulating structure, and comprising a second solenoid in communication with the transparent member and the second manipulating structure.

20. The work vehicle of claim 14, wherein the work vehicle is a skid steer loader or a tractor loader backhoe.
